(19) United States
(12) Patent Application Publication
(10) Pub. No.: US 2025/0024271 A1
(43) Pub. Date: Jan. 16, 2025

(54) RELAY DEVICE, BASE STATION DEVICE, WIRELESS COMMUNICATION SYSTEM, AND RELAY METHOD

(71) Applicant: FUJITSU LIMITED, Kawasaki-shi (JP)

(72) Inventors: Ryosuke KOBAYASHI, Kawasaki (JP); Tsuyoshi SHIMOMURA, Yokohama (JP); Yosuke AKIMOTO, Ichihara (JP)

(73) Assignee: FUJITSU LIMITED, Kawasaki-shi (JP)

(21) Appl. No.: 18/897,035

(22) Filed: Sep. 26, 2024

Related U.S. Application Data
(63) Continuation of application No. PCT/JP2022/018463, filed on Apr. 21, 2022.

(51) Int. Cl. H04W 16/28; H04B 7/06; H04W 72/231; H04W 76/10

(52) U.S. Cl. CPC H04W 16/28; H04B 7/06952; H04W 72/231; H04W 76/10

(57) ABSTRACT

A relay device includes: communication circuitry; and processor circuitry coupled to the communication circuitry, the processor circuitry being configured to perform processing including: first communication processing to receive a plurality of signals from a first wireless communication device via the communication circuitry; communication control processing to allocate, to each of the plurality of signals received by the first communication processing, a corresponding transmission timing and beam used for wireless communication; and second communication processing to transmit each signal to a second wireless communication device via the communication circuitry by using the beam allocated by the communication control processing, at the transmission timing allocated by the communication control processing, wherein the communication control processing includes receiving first information that includes a beam index indicating the beam.

### CROSS-REFERENCE TO RELATED APPLICATION

This application is a continuation application of International Application PCT/JP2022/018463 filed on Apr. 21, 2022 and designated the U.S., the entire contents of which are incorporated herein by reference.

### FIELD

The present disclosure relates to a relay device, a base station device, a wireless communication system, and a relay method.

### BACKGROUND

Currently, a mobile terminal device such as a smartphone has been widespread, and it is desired that a user can access a mobile communication network in any area or place. To access the mobile communication network by the mobile terminal device, a place where the mobile terminal device is positioned needs to be in a service area of the mobile communication network. Furthermore, even in the service area, many dead zones and interference zones exist in underground malls, buildings, or the like. In order to solve such a problem of service area shortage and a problem of dead zones and interference zones, measures for eliminating the dead zones and the interference zones have been taken by a relay device using a relay amplifier called a radio frequency (RF) repeater. In the following description, the radio frequency repeater is simply referred to as a repeater. The repeater amplifies and relays radio waves sent from a base station and delivers the radio waves to user equipment (UE).

Typically, the repeater has been used as a relay node that simply amplifies and transfers the received signal. Advantages of using the repeater include that the repeater is more inexpensive as compared with introduction of a base station or the like, is easily deployed for the reason, for example, that no license is needed in a case of energy saving, and has a less increase in a delay. That is, it can be said that the introduction of the repeater is cost-effective for coverage expanding. On the other hand, as a disadvantage of using the repeater, since there is a possibility that the repeater itself operates as an interference source, an increase in noise is concerned. In addition, the disadvantage includes that power consumption increases because the repeater is constantly turned on and a possibility of interference increases.

Therefore, in the fifth generation mobile communication (5G) studied as a next-generation communication standard, a technology has been proposed that gives Side Control Information to the repeater and controls the repeater, in order to efficiently extend a coverage of a network by the repeater. With this technology, it is possible to perform beamforming control, timing control, up link (UL)/down link (DL) time division duplex (TDD) configuration setting, on/off control, power control, or the like on the repeater.

This beamforming is one of technologies that have attracted attentions in 5G. This is the technology for realizing expansion of a cover area and cell capacity expansion by simultaneous communication with a plurality of users, by operating a plurality of antenna elements on one antenna in cooperation and forming a radio wave beam in an arbitrary direction.

Beamforming includes digital beamforming and analog beamforming. The digital beamforming has advantages that a capacity can be increased and a flexibility is high. However, the digital beamforming has a disadvantage that a configuration is complicated. Furthermore, although the analog beamforming has an advantage that a configuration is simple, the analog beamforming has a disadvantage that one beam is transmitted at a time.

Then, it is considered to secure a communicable distance and area between the base station and the UE, by performing communication using transmission beamforming in the base station. Since a reception strength of a signal is concentrated in a specific direction by applying the beamforming, a communication distance can be increased. On the other hand, since a reception strength decreases in other directions, a range where the signal reaches is narrowed.

Here, it is preferable to transmit a synchronization signal (SS), a physical broadcast channel (PBCH), or the like so as to reach all mobile terminal devices in a cell. Therefore, in the NR, the synchronization signal and the PBCH are defined by an SS/PBCH Block (SSB) that is one unit. One SSB is transmitted with a transmission beam in the same direction, and a configuration for sequentially switching beam directions and transmitting the plurality of SSBs (beam sweeping) has been proposed. The base station provides an important function of initial access and mobility to the UE using the SSB. A communication carrier can set a transmission timing and a transmission cycle of the SSB for each base station and notify the UE of the set timing and cycle.

Furthermore, in the 5G, it has been considered to use millimeter waves for communication, in order to increase a speed and a bandwidth of wireless communication. However, the communication using the millimeter waves has advantages including a high speed and a wide bandwidth. However, the communication using the millimeter waves has disadvantages that the communicable range is narrow and the communication is easily affected by an obstacle. Therefore, the repeater is used to cover such disadvantages of the millimeter waves.

Here, as a technology for extending the communication distance of the millimeter wave communication and expanding the coverage to the area to be the dead zone, a technology called integrated access and backhaul (IAB) has been developed. The IAB is wireless access backhaul integrated transmission, and is a technology for performing an operation as a relay of the millimeter wave communication between a plurality of new radio (NR) base stations. The IAB enables flexible and inexpensive network design by applying the NR to communication of a backhaul link. However, the repeater has advantages that the repeater does not need a license under certain conditions, the introduction is easier than the IAB, and the repeater then has flexibility in the network design.

Note that, as a repeater technology, a technology for receiving configuration information regarding an access procedure from the base station and transferring a signal to another wireless communication device based on the received access procedure has been proposed.

Examples of the related art include [Patent Document 1] U.S. Patent Application Publication No. 2021/0298069.

### SUMMARY

According to an aspect of the embodiments, there is provided a relay device including: communication circuitry; and processor circuitry coupled to the communication circuitry, the processor circuitry being configured to perform processing including: first communication processing to receive a plurality of signals from a first wireless communication device via the communication circuitry; communication control processing to allocate, to each of the plurality of signals received by the first communication processing, a corresponding transmission timing and beam used for wireless communication; and second communication processing to transmit each signal to a second wireless communication device via the communication circuitry by using the beam allocated by the communication control processing, at the transmission timing allocated by the communication control processing, wherein the communication control processing includes receiving first information that includes a beam index indicating the beam.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an overall diagram of a communication system using beamforming including a repeater.

FIG. 2 is a block diagram of a gNB and the repeater.

FIG. 3 is a diagram illustrating a configuration example of a newly set format of a DCI.

FIG. 4 is a diagram illustrating another configuration example of the newly set format of the DCI.

FIG. 5 is a diagram for explaining transmission of an SSB.

FIG. 6 is a flowchart of initial coupling between a gNB and a repeater according to a first embodiment.

FIG. 7 is a flowchart of communication processing after establishment of the initial coupling by a wireless communication system according to the first embodiment.

FIG. 8 is a flowchart of communication processing after establishment of initial coupling by a wireless communication system according to a second embodiment.

FIG. 9 is a flowchart of initial coupling between a gNB and a repeater according to a third embodiment.

FIG. 10 is a flowchart of communication processing after establishment of the initial coupling by a wireless communication system according to the third embodiment.

FIG. 11 is a flowchart illustrating communication processing after establishment of initial coupling by a wireless communication system according to a fourth embodiment.

FIG. 12 is a diagram for explaining an operation in a case where different beams at different timings are used to transmit a plurality of CSI-RSs.

### DESCRIPTION OF EMBODIMENTS

Here, in a typical wireless communication system, a base station transmits a signal using a beam different for each SSB, and a UE selects a beam having the largest reception power and communicates with the base station. Therefore, in a case where a repeater is applied to expand a coverage of millimeter waves, it is desirable to apply beamforming to the repeater. The repeater enables the UE to couple to the base station via the repeater, by relaying the signal such as an SSB from the base station.

However, in analog beamforming, it is difficult to simultaneously transmit the plurality of SSBs in the same cell. Since the repeater is housed in any one of the plurality of cells formed by using each beam by the base station, the single SSB is transmitted to the repeater. In a typical configuration in which the repeater transmits a single beam, in a case where the repeater relays a signal from the base station using an optimum beam, the single SSB is transmitted to the UE with the single beam, and it is difficult to provide a sufficient coverage.

Therefore, a method is considered for mounting a configuration for transmitting a plurality of beams on the repeater and improving coverage expansion efficiency. However, regarding the SSB periodically transmitted by the base station, in a case where the repeater transmits the SSB to the UE using another beam at another cycle, a one-to-one relationship between the beam and the SSB is not satisfied for the UE, and it is difficult for the UE to perform a correct operation. Therefore, coverage expansion is actually incomplete.

The disclosed technology has been made in view of the above, and an object is to provide a relay device, a base station device, a wireless communication system, and a relay method that expand a coverage of a communication range and eliminate a coverage hole.

Hereinafter, embodiments of a relay device, a base station device, a wireless communication system, and a relay method disclosed in the present application will be described in detail with reference to the drawings. Note that the following embodiments do not limit the relay device, the base station device, the wireless communication system, and the relay method disclosed in the present application.

### First Embodiment

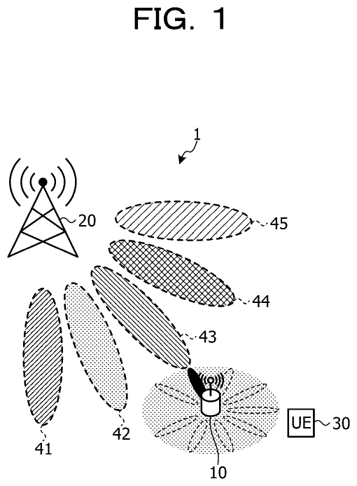

FIG. 1 is an overall diagram of a wireless communication system using beamforming including a repeater. A wireless communication system 1 according to the present embodiment includes a repeater 10 that is a relay device, a gNB 20 that is a wireless base station device of an NR, and a UE 30 that is a mobile terminal device.

The gNB 20 transmits a signal with a beam using beamforming. For example, the gNB 20 performs time division multiplexing (TDM) transmission (time division multiplexing transmission) of beams 41 to 45 and transmits the beams respectively in different directions at different timings. The beams respectively form different cells.

Furthermore, the gNB 20 provides important functions of initial access and mobility, specifically, a synchronization signal, a physical broadcast channel, and an index such as a wireless frame timing or a slot timing, to the UE 30 via the repeater 10, using an SSB. Then, after completing coupling to the UE 30 via the repeater 10 for data communication, the gNB 20 transmits and receives data to and from the UE 30 via the repeater 10. In FIG. 1, for example, the gNB 20 communicates with the repeater 10 using the beam 43 as an optimum beam. This gNB 20 corresponds to an example of a “first wireless communication device”. Furthermore, the UE 30 corresponds to an example of a “second wireless communication device”.

The repeater 10 receives a signal transmitted from the gNB 20 using beamforming. Then, the repeater 10 amplifies the received signal and transfers the signal to the UE using the beam formed by beamforming. Furthermore, the repeater 10 amplifies the signal received from the UE 30 and transfers the signal to the gNB 20.

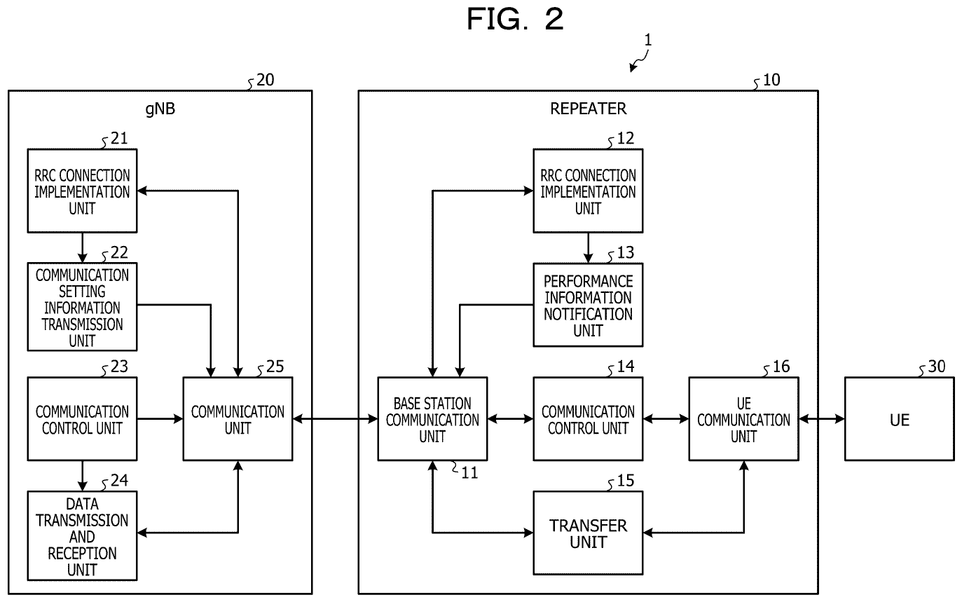

FIG. 2 is a block diagram of the gNB and the repeater. Hereinafter, details of the gNB 20 and the repeater 10 will be described with reference to FIG. 2.

The gNB 20 includes a radio resource control (RRC) connection implementation unit 21, a communication setting information transmission unit 22, a communication control unit 23, a data transmission and reception unit 24, and a communication unit 25. The RRC connection implementation unit 21, the communication setting information transmission unit 22, the communication control unit 23, and the data transmission and reception unit 24 are implemented by a processor and a memory. The processor includes, for example, a central processing unit (CPU), a field programmable gate array (FPGA), a digital signal processor (DSP), or the like. The communication unit 25 is implemented by a processor and a wireless communication circuit.

The communication unit 25 performs wireless communication with the repeater 10 using analog beamforming. The communication unit 25 relays communication between each unit of the initial coupling implementation unit 21, the communication setting information transmission unit 22, the communication control unit 23, and the data transmission and reception unit 24 and the repeater 10. The communication unit 25 executes processing such as frequency up-conversion, quadrature modulation, or amplification on a downlink signal output from each unit. Then, the communication unit 25 wirelessly transmits the processed downlink signal with a beam via an antenna in a downlink signal transmission period. Furthermore, the communication unit 25 receives an uplink signal via the antenna in an uplink signal transmission period, in a predetermined frequency band. Then, the communication unit 25 executes processing such as amplification, quadrature demodulation, or down-conversion on the received uplink signal and outputs the processed uplink signal.

However, in the following description, there is a case where it is described that relay of the communication unit 25 is omitted and each unit of the RRC connection implementation unit 21, the communication setting information transmission unit 22, the communication control unit 23, and the data transmission and reception unit 24 transmits and receives signals to and from the repeater 10.

The RRC connection implementation unit 21 executes an initial coupling procedure and establishes RRC connection, with the repeater 10. For example, the RRC connection implementation unit 21 performs reception of an RA preamble, transmission of an RA response, reception of an RRC connection request, transmission of RRC connection establishment, transmission of RRC connection completion, or the like. At this time, an optimum beam for communication is selected between the gNB 20 and the repeater 10. Thereafter, the gNB 20 and the repeater 10 communicate using the selected optimum beam. When the RRC connection is completed, the RRC connection implementation unit 21 transmits a notification of the RRC connection establishment to the communication setting information transmission unit 22.

The communication setting information transmission unit 22 receives the notification of the RRC connection establishment from the initial coupling implementation unit 21. Then, the communication setting information transmission unit 22 transmits communication setting information including information used to receive downlink control information (DCI) that is downlink control information to the repeater 10, using an RRC protocol. The information used to receive the DCI includes information such as a frequency resource for transmitting the DCI.

The communication control unit 23 acquires performance information of the repeater 10 transmitted from the repeater 10. The performance information of the repeater 10 includes information indicating presence or absence of a repeater function for notifying that a transmission source device is a repeater, the number of beams that can be transmitted and received, or the like. Here, after the RRC connection establishment, from the time when the gNB 20 transmits the communication setting information to the repeater 10 to the time when the gNB 20 receives the performance information from the repeater 10 is referred to as initial coupling.

Next, the communication control unit 23 generates a DCI for beam identifier (ID) notification used to notify the repeater 10 of operation information indicating a beam number of a beam used for transmission to the UE 30 in each symbol for each slot, according to the performance information of the repeater 10. The DCI for beam ID notification includes a newly set format of the DCI. The DCI for beam ID notification corresponds to an example of first information indicating a transmission timing and a beam to be allocated to each signal used to transmit the SSB or the like.

Then, the communication control unit 23 transmits the DCI for beam ID notification to the repeater 10 and notifies the repeater 10 of the operation information for each slot. The operation information included in the DCI for beam ID notification includes a beam ID for designating a beam used in each symbol of the slot for each slot number. The beam ID may be referred to as a spatial filter ID or a spatial domain filter ID.

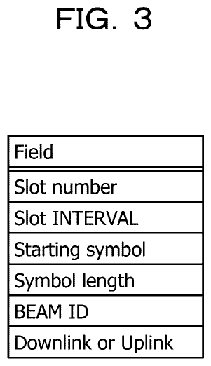

FIG. 3 is a diagram illustrating a configuration example of the newly set format of the DCI. For example, in the newly set format of the DCI used for the DCI for beam ID notification, as illustrated in FIG. 3, a slot number (slot number) and a slot interval (slot interval) are stored. Moreover, in this format, a number of a starting symbol (starting symbol), a symbol length (symbol length), a beam ID, and information indicating a downlink or uplink (downlink or uplink) are stored. However, as long as a correspondence relationship between a specific slot, a symbol, and a specific beam can be indicated, the newly set format of the DCI may have a configuration including a part of the information illustrated in FIG. 3. In this case, the DCI for beam ID notification is generated for each pair of the slot and the symbol and is sent to the repeater 10.

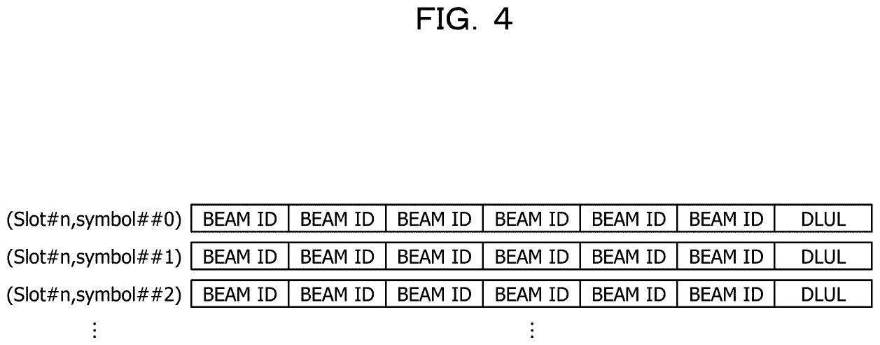

FIG. 4 is a diagram illustrating another configuration example of the newly set format of the DCI. Here, for example, a slot #n is illustrated as a slot #n, and a symbol ##0 is illustrated as a symbol ##0. As illustrated in FIG. 4, the newly set format of the DCI may be created to designate the beam ID used for each symbol for each slot with a bitmap. In this case, the communication control unit 23 registers the beam ID represented by the bitmap and display of downlink or uplink (DLUL), in association with a pair of the slot and the symbol illustrated on the left side on the paper surface of FIG. 4. For example, a beam used by the symbol ##0 of the slot #n is represented by six bits described on the right side toward the paper surface.

Thereafter, the communication control unit 23 transmits an SIB transmitted toward the UE 30 with a specific beam to the repeater 10 in a slot and a symbol for designating use of the specific beam and performs scheduling. In this case, the communication control unit 23 transmits the SIB using a DCI format 0. Moreover, the communication control unit 23 transmits an SSB transmitted toward the UE 30 with the specific beam, to the repeater 10, using the DCI with the slot and the symbol designated by the SIB. The slot and the symbol are a slot and a symbol for designating the use of the specific beam. The communication control unit 23 transmits the SSB using resources for four symbols.

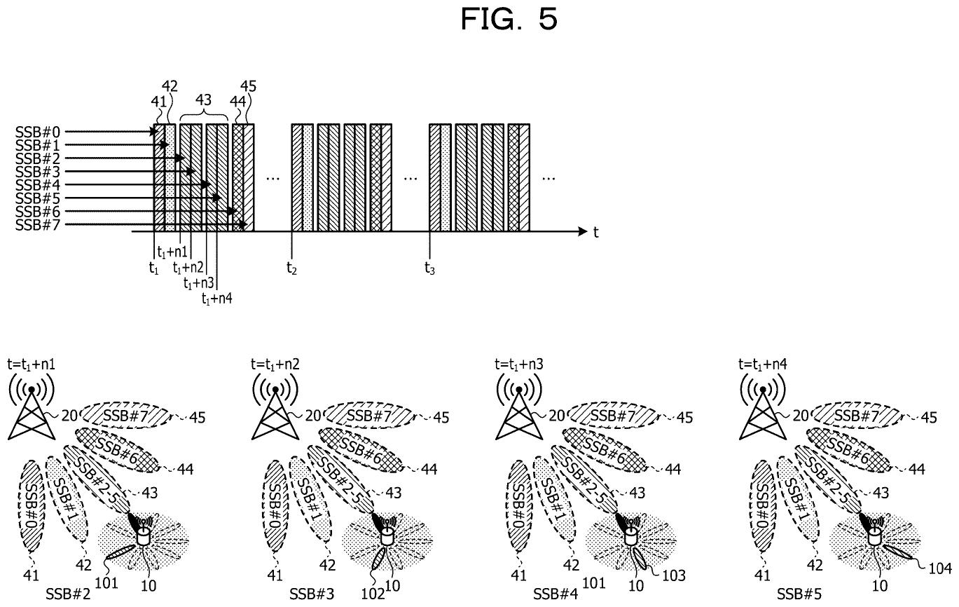

FIG. 5 is a diagram for explaining transmission of the SSB. The communication control unit 23 transmits, for example, 64 SSBs at a maximum at a cycle of 20 msec. In FIG. 5, each interval between times t1, t2, and t3 is 20 msec. The communication control unit 23 transmits the SSB in order from the time t1. In FIG. 5, the communication control unit 23 repeats transmitting the SSBs #0, #1, #2 . . . in order at the cycle of 20 msec. However, the maximum number of SSBs that can be transmitted is 64, and the number of SSBs transmitted by the communication control unit 23 may be equal to or less than 64. In FIG. 5, the beam 43 is the optimum beam between the gNB 20 and the repeater.

The communication control unit 23 transmits the SSB #0 using the beam 41, and transmits the SSB #1 using the beam 42. Next, the communication control unit 23 TDM-transmits each of the SSBs #2 to #5 using the beam 43. For example, the communication control unit 23 transmits the SSB #2 using the beam 43 at a time t+n1. Furthermore, the communication control unit 23 transmits the SSB #3 using the beam 43 at a time t+n2. Furthermore, the communication control unit 23 transmits the SSB #4 using the beam 43 at a time t+n3. Moreover, the communication control unit 23 transmits the SSB #5 using the beam 43 at a time t+n4.

Thereafter, the communication control unit 23 repeats the notification of the beam ID of the beam used in each slot and symbol, using the DCI for beam ID notification, from the time when the connection for data communication is established to the time when the connection is disconnected and during the data transmission. For example, the communication control unit 23 receives a signal strength for each SSB transmitted from the UE 30, determines a beam to be used, and establishes connection for data communication. Thereafter, the communication control unit 23 notifies the data transmission and reception unit of the establishment of the connection for data communication with the UE 30. Moreover, the communication control unit 23 notifies the data transmission and reception unit 24 of a schedule indicating the slot and the symbol for transmitting the beam used for the communication with the UE 30.

The data transmission and reception unit 24 receives the notification of the establishment of the connection for data communication with the UE 30. Moreover, the data transmission and reception unit 24 receives the schedule indicating the slot and the symbol for transmitting the beam used for the communication with the UE 30. Then, the data transmission and reception unit 24 transmits data to the UE 30 according to the notified schedule.

Next, the repeater 10 will be described. The repeater 10 according to the present embodiment has a function similar to a mobile terminal device such as the UE 30 that establishes the initial coupling with the gNB 20. Furthermore, the repeater 10 performs wireless communication with the UE 30 using analog beamforming. The repeater 10 includes a base station communication unit 11, an RRC connection implementation unit 12, a performance information notification unit 13, a communication control unit 14, a transfer unit 15, and a UE communication unit 16. The RRC connection implementation unit 12, the performance information notification unit 13, the communication control unit 14, and the transfer unit 15 are implemented by a processor and a memory. The processor includes, for example, a CPU, an FPGA, a DSP, or the like. The base station communication unit 11 and the UE communication unit 16 are implemented by a processor and a wireless communication circuit.

The base station communication unit 11 transmits and receives a signal using a beam to and from the communication unit 25 of the gNB 20. For example, the base station communication unit 11 receives a plurality of different SSBs through TDM-transmission. The base station communication unit 11 outputs the signal received from the gNB 20 to the performance information notification unit 13, the communication control unit 14, or the transfer unit 15 according to a destination. Furthermore, the base station communication unit 11 acquires the signal to be transmitted to the gNB 20 from the performance information notification unit 13, the communication control unit 14, or the transfer unit 15 and transmits the signal to the communication unit 25 of the gNB 20. In the following description, there is a case where the base station communication unit 11 is omitted and it is described that the RRC connection implementation unit 12, the performance information notification unit 13, the communication control unit 14, and the transfer unit 15 communicate with the gNB 20. The base station communication unit 11 corresponds to an example of a “first communication unit”.

The RRC connection implementation unit 12 executes the initial coupling procedure and establishes the RRC connection, with the gNB 20. For example, the RRC connection implementation unit 12 performs transmission of the RA preamble, reception of the RA response, transmission of the RRC connection request, reception of the RRC connection establishment, reception of the RRC connection completion, or the like. Furthermore, the RRC connection implementation unit 12 notifies the performance information notification unit 13 of the establishment of the RRC connection.

The performance information notification unit 13 receives the notification of the establishment of the RRC connection from the RRC connection implementation unit 12. Next, the performance information notification unit 13 transmits the performance information of the repeater 10 including the information indicating that the repeater 10 has the repeater function, the number of beams that can be transmitted and received, or the like, to the gNB 20.

After completing the establishment of the RRC connection, the communication control unit 14 receives the communication setting information used to receive the DCI from the communication setting information transmission unit 22 of the gNB 20 via the base station communication unit 11. Thereafter, the communication control unit 14 receives the DCI according setting such as the frequency resource for transmitting the DCI included in the communication setting information.

The communication control unit 14 acquires the DCI for beam ID notification. Then, the communication control unit 14 acquires the operation information for each slot included in the received DCI for beam ID notification and confirms the beam ID of the beam used for each symbol for each slot designated in the operation information. In a case where there is a range of a slot of which a beam ID is designated by the DCI for beam ID notification, the communication control unit 14 sequentially acquires the DCI for beam ID notification for a slot in a subsequent range and repeats confirmation of the beam used for each symbol for each slot.

Then, the communication control unit 14 determines a slot and a packet used by the signal received by the base station communication unit 11 from the communication unit 25 of the gNB 20 and specifies a beam ID of a beam corresponding to the slot and the packet. Then, the communication control unit 14 notifies the UE communication unit 16 of the information regarding the slot and the packet and the specified beam ID and instructs the UE communication unit 16 to use the specified beam for the transmission of the signal in the slot and the packet.

For example, when the base station communication unit 11 receives the SIB, the communication control unit 14 specifies the beam corresponding to the slot and the symbol of the signal. Then, the communication control unit 14 instructs the UE communication unit 16 to transmit the signal to the UE 30 using the specified beam, in the slot and the symbol for transmitting the SIB. Here, since the RRC connection is established between the repeater 10 and the gNB 20, the communication control unit 14 can acquire information regarding a reception timing of the signal transmitted from the UE 30 with respect to the transmitted signal, from the SIB.

Furthermore, when receiving the SSB, the communication control unit 14 specifies the beam corresponding to the slot and the symbol of the signal. Then, the communication control unit 14 instructs the UE communication unit 16 to transmit the signal to the UE 30 using the specified beam, in the slot and the symbol for transmitting the SSB.

The transfer unit 15 receives the signal transmitted from the gNB 20 via the base station communication unit 11. Then, the transfer unit 15 outputs the signal to the UE communication unit 16 so as to transmit the signal in the received slot and symbol. Furthermore, the transfer unit 15 receives the signal transmitted from the UE 30, via the UE communication unit 16. Then, the transfer unit 15 outputs the signal to the base station communication unit 11 so as to transmit the signal in the received slot and symbol.

The UE communication unit 16 transmits and receives the signal to and from the UE 30 using beamforming. The UE communication unit 16 transmits the signal output from the transfer unit 15, to the UE 30 using the beam. Furthermore, the UE communication unit 16 receives the signal transmitted from the UE 30 and outputs the signal to the transfer unit 15.

The UE communication unit 16 receives the notification of the beam ID of the beam used for the transmission in each symbol for each slot, from the communication control unit 14. Furthermore, the UE communication unit 16 receives input of the signal transmitted in each symbol for each slot from the transfer unit 15. Then, the UE communication unit 16 transmits the signal input from the transfer unit 15 to the UE 30 in the slot and the symbol, using the beam to which the beam ID corresponding to the slot and the symbol used to transmit the signal is allocated. For example, the UE communication unit 16 transmits the SIB and the SSB to the UE 30 in each slot and symbol, using the beam designated by the slot and the packet used to transmit each of the SIB and the SSB. This UE communication unit 16 corresponds to an example of a “second communication unit”.

For example, in FIG. 5, the communication control unit 14 notifies the UE communication unit 16 of that a beam 101 is used in a slot and a symbol of a signal transmitted at a time t1+n1. The UE communication unit 16 acquires the SSB #2 transmitted at the time t1+n1 from the transfer unit 15 and transmits the SSB #2 to the UE 30 using the beam 101 in the received slot and symbol. Furthermore, the communication control unit 14 notifies the UE communication unit 16 of that a beam 102 is used in a slot and a symbol of a signal transmitted at a time t1+n2. The UE communication unit 16 acquires the SSB #3 transmitted at the time t1+n2 from the transfer unit 15 and transmits the SSB #3 to the UE 30 using the beam 102 in the received slot and symbol. Furthermore, the communication control unit 14 notifies the UE communication unit 16 of that a beam 103 is used in a slot and a symbol of a signal transmitted at a time t1+n3. The UE communication unit 16 acquires the SSB #4 transmitted at the time t1+n3 from the transfer unit 15 and transmits the SSB #4 to the UE 30 using the beam 103 in the received slot and symbol. Furthermore, the communication control unit 14 notifies the UE communication unit 16 of that a beam 104 is used in a slot and a symbol of a signal transmitted at a time t1+n4. The UE communication unit 16 acquires the SSB #5 transmitted at the time t1+n4 from the transfer unit 15 and transmits the SSB #5 to the UE 30 using the beam 104 in the received slot and symbol.

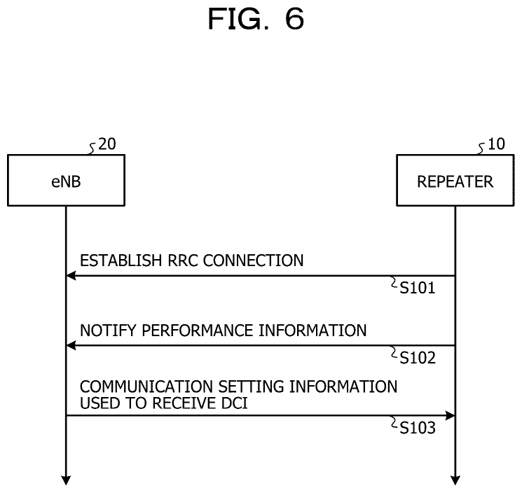

FIG. 6 is a flowchart of initial coupling between the gNB and the repeater according to the first embodiment. Next, a flow of the initial coupling between the gNB 20 and the repeater 10 according to the present embodiment will be described with reference to FIG. 6.

The RRC connection implementation unit 21 of the gNB 20 and the RRC connection implementation unit 12 of the repeater 10 execute the initial coupling procedure and establish the RRC connection (step S101).

After the establishment of the RRC connection, the performance information notification unit 13 of the repeater 10 transmits the performance information of the repeater 10 including presence or absence of the repeater function and the number of beams that can be transmitted and received, to the gNB 20 (step S102).

Next, the communication setting information transmission unit 22 of the gNB 20 receives a notification indicating the completion of the RRC connection from the initial coupling implementation unit 21. Then, the communication setting information transmission unit 22 of the gNB 20 transmits the communication setting information used to receive the DCI to the communication control unit 14 of the repeater 10 (step S103). As a result, the communication control unit 14 of the repeater 10 can receive the DCI according to setting notified in the received communication setting information.

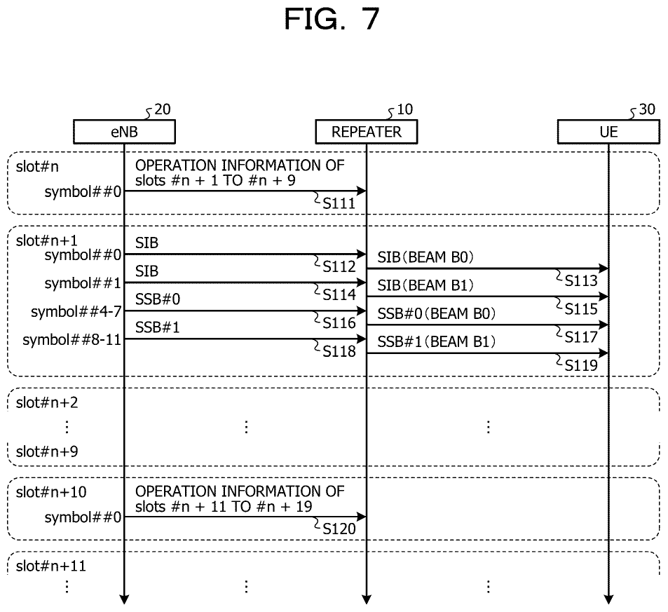

FIG. 7 is a flowchart of communication processing after the establishment of the initial coupling by the wireless communication system according to the first embodiment. Next, a flow of the communication processing after the establishment of the initial coupling by the wireless communication system 1 according to the present embodiment will be described with reference to FIG. 7. In FIG. 7, a beam used for communication between the repeater 10 and the UE 30 is indicated in parentheses following information to be sent. Hereinafter, the communication unit 25 of the gNB 20 communicates with the repeater 10, using the optimum beam with the repeater 10.

The communication control unit 23 of the gNB 20 transmits operation information of slots #n+1 to #n+9 in the symbol ##0 of the slot #n using the DCI for beam ID notification, to the repeater 10 via the communication unit 25. The communication control unit 14 of the repeater 10 receives the DCI for beam ID notification in the symbol ##0 of the slot #n and acquires the operation information of the slots #n+1 to #n+9 (step S111). At this time, the operation information of the slots #n+1 to #n+9 transmitted by the communication control unit 23 includes, for example, information indicating that a beam B0 is used in the symbol ##0 of the slot #n+1 and a beam B1 is used in a symbol ##1 of the slot #n+1. Furthermore, the operation information of the slots #n+1 to #n+9 includes information indicating that the beam B0 is used in a symbol ##4-7 of the slot #n+1 and the beam B0 is used in a symbol ##8-11 of the slot #n+1.

Next, in the symbol ##0 of the slot #n+1, the communication control unit 23 of the gNB 20 transmits the SIB to the repeater 10 using the DCI format 0 and performs scheduling (step S112).

Since the signal is transmitted in the symbol ##0 of the slot #n+1, the communication control unit 14 of the repeater 10 specifies to use the beam B0 and instructs the UE communication unit 16 to use the beam B0 in a case where the signal of the symbol ##0 of the slot #n+1 is transmitted to the UE 30. The transfer unit 15 of the repeater 10 outputs the scheduling of the SIB received via the base station communication unit 11, to the UE communication unit 16 so as to transmit the scheduling in the symbol ##0 of the slot #n+1. Then, the UE communication unit 16 of the repeater 10 transmits the SIB to the UE 30 using the beam B0 in the symbol ##0 of the slot #n+1, according to an instruction from the communication control unit 14 and performs scheduling (step S113).

Next, in the symbol ##1 of the slot #n+1, the communication control unit 23 of the gNB 20 transmits the SIB to the repeater 10 using the DCI format 0 (step S114).

Since the signal is transmitted in the symbol ##1 of the slot #n+1, the communication control unit 14 of the repeater 10 specifies to use the beam B1 and instructs the UE communication unit 16 to use the beam B1 in a case where the signal of the symbol ##1 of the slot #n+1 is transmitted to the UE 30. The transfer unit 15 of the repeater 10 outputs the SIB received via the base station communication unit 11 to the UE communication unit 16 so as to transmit the SIB in the symbol ##1 of the slot #n+1. Then, the UE communication unit 16 of the repeater 10 transmits the SIB to the UE 30 using the beam B1 in the symbol ##1 of the slot #n+1, according to an instruction from the communication control unit 14 and performs scheduling (step S115).

Next, in the symbol ##4-7 of the slot #n+1, the communication control unit 23 of the gNB 20 transmits the SSB #0 to the repeater 10 using the DCI (step S116). In the present embodiment, four symbols are used to transmit the SSB.

Since the signal is transmitted in the symbol ##4-7 of the slot #n+1, the communication control unit 14 of the repeater 10 specifies to use the beam B0. Then, the communication control unit 14 instructs the UE communication unit 16 to use the beam B0 in a case where the signal of the symbol ##4-7 of the slot #n+1 is transmitted to the UE 30. The transfer unit 15 outputs the SSB #0 received via the base station communication unit 11 to the UE communication unit 16 so as to transmit the SSB #0 in the symbol ##4-7 of the slot #n+1. The UE communication unit 16 of the repeater 10 transmits the SSB #0 to the UE 30 using the beam B0 in the symbol ##4-7 of the slot #n+1, according to an instruction from the communication control unit 14 (step S117).

Next, in a symbol ##8-11 of the slot #n+1, the communication control unit 23 of the gNB 20 transmits the SSB #1 to the repeater 10 using the DCI (step S118).

Since the signal is transmitted in the symbol ##8-11 of the slot #n+1, the communication control unit 23 specifies to use the beam B1 and instructs the UE communication unit 16 to use the beam B1 in a case where the signal of the symbol ##8-11 of the slot #n+1 is transmitted to the UE 30. The transfer unit 15 outputs the SSB #1 received via the base station communication unit 11 to the UE communication unit 16 so as to transmit the SSB #1 in the symbol ##8-11 of the slot #n+1. The UE communication unit 16 of the repeater 10 transmits the SSB #1 to the UE 30 using the beam B1 in the symbol ##8-11 of the slot #n+1, according to an instruction from the communication control unit 23 (step S119).

Thereafter, in the slots #n+2 to #n+9, the repeater 10 transmits the signal transmitted from the gNB 20, to the UE 30 using the beam designated in the operation information.

Then, when the slot #9 in which the operation information is transmitted ends, in a symbol ##0 of the next slot #n+10, the communication control unit 23 of the gNB 20 transmits operation information of slots #n+11 to #n+19 to the repeater 10 via the communication unit 25, using the DCI for beam ID notification. The communication control unit 14 of the repeater 10 receives the DCI for beam ID notification in the symbol ##0 of the slot #n+10 and acquires the operation information of the slots #n+11 to #n+19 (step S120). Thereafter, the repeater 10 transmits the signal to the UE 30 using the beam in which the operation information of the slots #n+11 to #n+19 is designated. Hereinafter, the gNB 20 repeats transmitting the operation information of each slot. The repeater 10 repeats transmitting the signal to the UE 30 using the beam designated in the operation information, for each slot.

In FIG. 7, a part of the communication at the time of connection establishment has been described as an example. However, the gNB 20 and the repeater 10 similarly communicate at the time of data transmission and reception and connection disconnection.

As described above, in the communication system according to the present embodiment, the repeater has the function of the UE and can establish the RRC connection with the gNB. As a result, the repeater can receive a control signal from the gNB via the UE function. Then, the gNB transmits the DCI for beam ID notification to the repeater, and the repeater performs scheduling of the beam to be used for each symbol for each slot. Thereafter, the gNB TDM-transmits the plurality of SSBs to the repeater with the optimum beam between the gNB and the repeater. The repeater transmits the different SSBs with the respective beams to the UE, according to the set schedule.

As a result, the UE can recognize the beam and the SSB in a one-to-one relationship, and even with a configuration in which beams are sequentially switched so as to expand a coverage when communication is performed using beamforming, the gNB and the UE can appropriately communicate via the repeater. As a result, even in a case where communication is performed using millimeter waves, it is possible to reduce a dead band, to eliminate a coverage hole, and to provide a wide coverage.

Furthermore, in the wireless communication system according to the present embodiment, by using the repeater, installation is easier than an IAB, and flexible and inexpensive network design is possible.

### Second Embodiment

Next, a second embodiment is described. A wireless communication system 1 according to the present embodiment is different from that in the first embodiment in that a gNB 20 instructs a repeater 10 using an RRC parameter that is a parameter at the time of establishment of connection for wireless resource control, before SSB transmission and reception of a msg.1. The wireless communication system 1 according to the present embodiment is also represented by the block diagram in FIG. 2. In the following description, explanation of operations of the respective components similar to those of the first embodiment is omitted.

A communication control unit 23 of the gNB 20 notifies a communication control unit 14 of the repeater 10 of an SSB, a reception timing of a msg.1/A, a beam ID, a transmission timing of each SSB, and a use timing of a beam, using the RRC parameter. Specifically, the communication control unit 23 includes the SSB, the beam ID, and information regarding a slot and a symbol used for transmission in the RRC parameter and transmits the RRC parameter to the communication control unit 14 of the repeater 10. The communication control unit 23 causes the communication control unit 14 to recognize the reception timing of the msg.1/A, by causing the communication control unit 14 of the repeater 10 to read an SIB for a UE 30. Here, as long as the information to be included in the RRC parameter can indicate a correspondence relationship between a specific slot and symbol, a specific beam, and an SSB, the RRC parameter may have a configuration including a part of the above information.

After receiving the msg.1/A, the communication control unit 23 notifies the communication control unit 14 of the beam ID of the beam used for each symbol for each slot using a DCI for beam ID notification. As a format of the DCI for beam ID notification used in the present embodiment, the format illustrated in FIG. 3 can be used. However, in a case of a format illustrated in FIG. 4, since scheduling regarding the SSB and the msg.1/A overlaps scheduling notified by an RRI parameter, the use of the format illustrated in FIG. 4 is not suitable for the wireless communication system 1 according to the present embodiment.

The communication control unit 14 of the repeater 10 receives the RRC parameter including the SSB, the beam ID, and the information regarding the slot and the symbol used for transmission. Then, before transmitting the msg.1/A to the gNB 20, the communication control unit 14 notifies a UE communication unit 16 of the beam ID designated by the RRC parameter in each symbol of each slot. At this time, the communication control unit 14 transmits each SSB to the UE communication unit 16 in each slot and symbol designated by the RRC parameter.

Furthermore, the communication control unit 14 refers to RACH config included in the SIB transmitted to the UE 30 and acquires the reception timing of the msg.1/A. Then, the communication control unit 14 notifies the UE communication unit 16 of the acquired reception timing of the msg.1/A and causes the UE communication unit 16 to receive the msg.1/A transmitted from the UE 30.

When the transmission of the msg.1/A to the gNB 20 is completed, the communication control unit 14 receives the DCI for beam ID notification via a base station communication unit 11. Then, the communication control unit 14 notifies the UE communication unit 16 of the beam ID corresponding to each symbol for each slot notified by the DCI for beam ID notification and instructs the beam to be used for each symbol for each slot.

The UE communication unit 16 receives the notification of the beam ID corresponding to each symbol of each slot notified by the RRC parameter, from the communication control unit 14. Then, the UE communication unit 16 transmits the signal to the UE 30 using a beam to which the corresponding beam ID is allocated, in each symbol for each slot. Furthermore, the UE communication unit 16 receives the SSB notified by the RRC parameter and the notification of the slot and the symbol used to transmit each SSB, from the communication control unit 14. Then, the UE communication unit 16 transmits the SSB designated by the designated slot and symbol, to the UE 30 using the designated beam.

Furthermore, the UE communication unit 16 receives the notification of the reception timing of the msg.1/A from the communication control unit 14. Then, the UE communication unit 16 receives the msg.1/A transmitted from the UE 30 at the notified timing. Thereafter, the UE communication unit 16 outputs the received msg.1/A to a transfer unit 15 and transfers the msg.1/A to the gNB 20 via the base station communication unit 11.

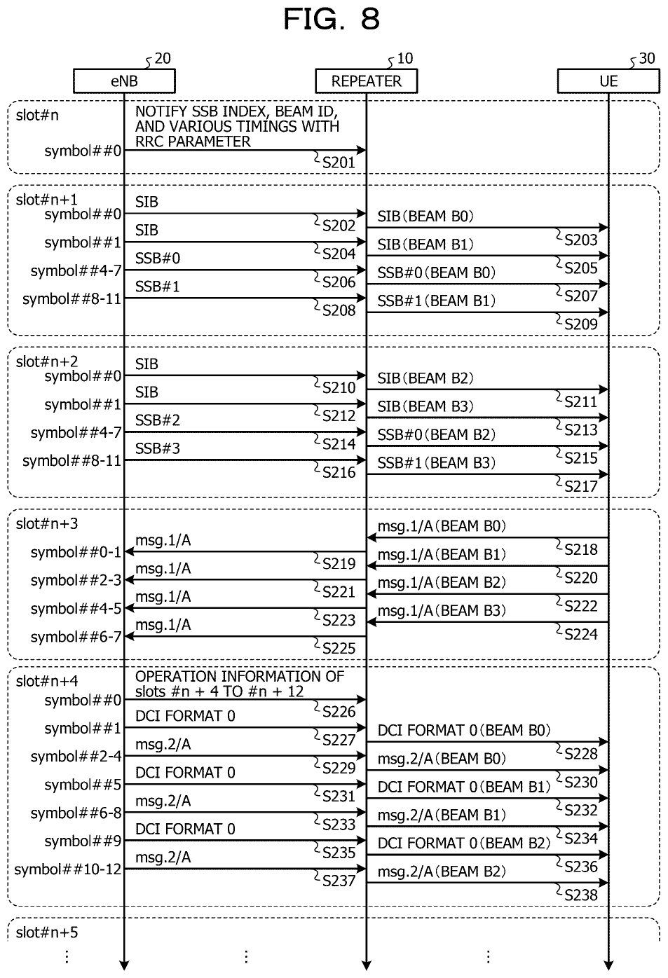

FIG. 8 is a flowchart of communication processing after establishment of initial coupling by the wireless communication system according to the second embodiment. Next, a flow of the communication processing after the establishment of the initial coupling by the wireless communication system 1 according to the present embodiment will be described with reference to FIG. 8. Hereinafter, the communication unit 25 of the gNB 20 communicates with the repeater 10, using the optimum beam with the repeater 10.

The communication control unit 23 of the gNB 20 transmits the SSB, the beam ID, and various transmission timings to the repeater 10 with the RRC parameter in a symbol ##0 of a slot #n, using the optimum beam with the repeater 10 (step S201). Here, the following information is included in the RRC parameter. Symbols ##0 and ##4-7 of a slot #n+1 are transmission timings of a beam B0, and a symbol #4-7 of the slot #n+1 is a transmission timing of a BBS #0. Furthermore, symbols ##1 and ##8-11 of the slot #n+1 are transmission timings of a beam B1, and the symbol #8-11 of the slot #n+1 is a transmission timing of a BBS #1. Furthermore, symbols ##0 and ##4-7 of a slot #n+2 are transmission timings of a beam B2, and the symbol #4-7 of the slot #n+2 is a transmission timing of a BBS #2. Furthermore, symbols ##1 and ##8-11 of the slot #n+2 are transmission timings of a beam B3, and the symbol #8-11 of the slot #n+2 is a transmission timing of a BBS #3. The communication control unit 14 of the repeater 10 notifies the UE communication unit 16 of the repeater 10, of the SSB, the beam ID, and various transmission timings notified by the RRC parameter.

Next, in the symbol ##0 of the slot #n+1, the communication control unit 23 of the gNB 20 transmits the SIB to the repeater 10 using the DCI format 0 and performs scheduling (step S202). The communication control unit 14 of the repeater 10 refers to the received SIB and confirms that the reception timing of the msg.1/A with respect to the signal is a symbol ##0-1 of a slot #n+3. Furthermore, the communication control unit 14 of the repeater 10 confirms that the msg.1/A for this signal is received with the beam B0 corresponding to the symbol ##0 of the slot #n+1 designated by the RRC parameter. Then, the communication control unit 14 of the repeater 10 notifies the UE communication unit 16 of that the msg.1/A for this signal is received with the beam B0 in the symbol ##0-1 of the slot #n+3.

The UE communication unit 16 of the repeater 10 transmits the SIB to the UE 30 in the symbol ##0 of the slot #n+1 using the beam B0 notified by the RRC parameter and performs scheduling (step S203).

Next, the communication control unit 23 of the gNB 20 transmits the SIB to the repeater 10 using a DCI format 1 in the symbol ##1 of the slot #n+1 and performs scheduling (step S204). The communication control unit 14 of the repeater 10 refers to the received SIB and confirms that the reception timing of the msg.1/A for this signal is a symbol ##2-3 of the slot #n+3 and reception is performed by the beam B1. Then, the communication control unit 14 of the repeater 10 notifies the UE communication unit 16 of that the msg.1/A for this signal is received with the beam B1 in the symbol ##2-3 of the slot #n+3.

The UE communication unit 16 of the repeater 10 transmits the SIB to the UE 30 in the symbol ##1 of the slot #n+1 using the beam B1 notified by the RRC parameter and performs scheduling (step S205).

Next, the communication control unit 23 of the gNB 20 transmits the SSB #0 to the repeater 10 in the symbol ##4-7 of the slot #n+1 (step S206).

The UE communication unit 16 of the repeater 10 transmits the SSB #0 to the UE 30 in the symbol ##4-7 of the slot #n+1 using the beam B0 notified by the RRC parameter (step S207).

Next, the communication control unit 23 of the gNB 20 transmits the SSB #1 to the repeater 10 in the symbol ##8-11 of the slot #n+1 (step S208).

The UE communication unit 16 of the repeater 10 transmits the SSB #1 to the UE 30 in the symbol ##8-11 of the slot #n+1 using the beam B1 notified by the RRC parameter (step S209).

Next, the communication control unit 23 of the gNB 20 transmits the SIB to the repeater 10 using the DCI format 0 in the symbol ##0 of the slot #n+2 and performs scheduling (step S210). The communication control unit 14 of the repeater 10 refers to the received SIB and confirms that the reception timing of the msg.1/A for this signal is a symbol ##4-5 of the slot #n+3 and reception is performed by the beam B2. Then, the communication control unit 14 of the repeater 10 notifies the UE communication unit 16 of that the msg.1/A for this signal is received with the beam B2 in the symbol ##4-5 of the slot #n+3.

The UE communication unit 16 of the repeater 10 transmits the SIB to the UE 30 in the symbol ##0 of the slot #n+2 using the beam B2 notified by the RRC parameter and performs scheduling (step S211).

Next, the communication control unit 23 of the gNB 20 transmits the SIB to the repeater 10 using the DCI format 0 in the symbol ##1 of the slot #n+2 and performs scheduling (step S212). The communication control unit 14 of the repeater 10 refers to the received SIB and confirms that the reception timing of the msg.1/A for this signal is a symbol ##6-7 of the slot #n+3 and reception is performed by the beam B3. Then, the communication control unit 14 of the repeater 10 notifies the UE communication unit 16 of that the msg.1/A for this signal is received with the beam B3 in the symbol ##6-7 of the slot #n+3.

The UE communication unit 16 of the repeater 10 transmits the SIB to the UE 30 in the symbol ##1 of the slot #n+2 using the beam B2 notified by the RRC parameter and performs scheduling (step S213).

Next, the communication control unit 23 of the gNB 20 transmits the SSB #2 to the repeater 10 in the symbol ##4-7 of the slot #n+2 (step S214).

The UE communication unit 16 of the repeater 10 transmits the SSB #2 to the UE 30 in the symbol ##4-7 of the slot #n+2 using the beam B2 notified by the RRC parameter (step S215).

Next, the communication control unit 23 of the gNB 20 transmits the SSB #3 to the repeater 10 in the symbol ##8-11 of the slot #n+2 (step S216).

The UE communication unit 16 of the repeater 10 transmits the SSB #3 to the UE 30 in the symbol ##8-11 of the slot #n+2 using the beam B3 notified by the RRC parameter (step S217).

Next, the UE communication unit 16 of the repeater 10 receives the msg.1/A of communication using the SSB #0 transmitted from the UE 30, with the beam B0, in the symbol ##0-1 of the slot #n+3, according to an instruction from the communication control unit 23 (step S218).

Next, the UE communication unit 16 of the repeater 10 transmits the msg.1/A of the communication using the SSB #0 to the gNB 20 in the symbol ##0-1 of the slot #n+3 using the optimum beam (step S219).

Next, the UE communication unit 16 of the repeater 10 receives the msg.1/A of communication using the SSB #1 transmitted from the UE 30, with the beam B1, in the symbol ##2-3 of the slot #n+3, according to an instruction from the communication control unit 23 (step S220).

Next, the UE communication unit 16 of the repeater 10 transmits the msg.1/A of the communication using the SSB #1 to the gNB 20 in the symbol ##2-3 of the slot #n+3 using the optimum beam (step S221).

Next, the UE communication unit 16 of the repeater 10 receives the msg.1/A of communication using the SSB #2 transmitted from the UE 30, with the beam B2, in the symbol ##4-5 of the slot #n+3, according to an instruction from the communication control unit 23 (step S222).

Next, the UE communication unit 16 of the repeater 10 transmits the msg.1/A of the communication using the SSB #2 to the gNB 20 in the symbol ##4-5 of the slot #n+3 using the optimum beam (step S223).

Next, the UE communication unit 16 of the repeater 10 receives the msg.1/A of communication using the SSB #3 transmitted from the UE 30, with the beam B3, in the symbol ##6-7 of the slot #n+3, according to an instruction from the communication control unit 23 (step S224).

Next, the UE communication unit 16 of the repeater 10 transmits the msg.1/A of the communication using the SSB #3 to the gNB 20 in the symbol ##6-7 of the slot #n+3 using the optimum beam (step S225).

Thereafter, the communication control unit 23 of the gNB 20 transmits operation information of slots #n+4 to #n+12 in a symbol ##0 of the slot #n+4 using the DCI for beam ID notification, to the repeater 10 via the communication unit 25. The communication control unit 14 of the repeater 10 receives the DCI for beam ID notification in the symbol ##0 of the slot #n and acquires the operation information of the slots #n+1 to #n+9 (step S226). At this time, the operation information of the slots #n+4 to #n+12 transmitted by the communication control unit 23 includes, for example, information indicating that the beam B0 is used in a symbol ##1-4 of the slot #n+4, the beam B1 is used in a symbol ##5-8 of the slot #n+4, and the beam B2 is used in a symbol ##9-12 of the slot #n+4.

Next, in the symbol ##1 of the slot #n+4, the communication control unit 23 of the gNB 20 transmits a signal in the DCI format 0 to the repeater 10 (step S227).

Since the signal is transmitted in the symbol ##1 of the slot #n+4, the communication control unit 23 of the repeater 10 specifies to use the beam B0 and instructs the UE communication unit 16 to use the beam B0 in a case where the signal of the symbol ##1 of the slot #n+4 is transmitted to the UE 30. The transfer unit 15 of the repeater 10 outputs the signal in the DCI format 0 received via the base station communication unit 11 to the UE communication unit 16 so as to transmit the signal in the symbol ##1 of the slot #n+4. Then, the UE communication unit 16 of the repeater 10 transmits the signal in the DCI format 0 to the UE 30 using the beam B0 in the symbol ##1 of the slot #n+4, according to an instruction from the communication control unit 23 (step S228).

Next, in a symbol ##2-4 of the slot #n+4, the communication control unit 23 of the gNB 20 transmits a msg.2/A of communication using a DDB #0 to the repeater 10 using the DCI (step S229).

Since the signal is transmitted in the symbol ##2-4 of the slot #n+4, the communication control unit 23 specifies to use the beam B0 and instructs the UE communication unit 16 to use the beam B0 in a case where the signal of the symbol ##4-7 of the slot #n+4 is transmitted to the UE 30. The transfer unit 15 outputs the msg.2/A of the communication using the DDB #0 received via the base station communication unit 11 to the UE communication unit 16 so as to transmit the msg.2/A in the symbol ##2-4 of the slot #n+4. The UE communication unit 16 of the repeater 10 transmits the msg.2/A of the communication using the DDB #0 to the UE 30 using the beam B0 in the symbol ##2-4 of the slot #n+4, according to an instruction from the communication control unit 23 (step S230).

Next, in a symbol ##5 of the slot #n+4, the communication control unit 23 of the gNB 20 transmits a signal in the DCI format 0 to the repeater 10 (step S231).

Since the signal is transmitted in the symbol ##5 of the slot #n+4, the communication control unit 23 specifies to use the beam B1 and instructs the UE communication unit 16 to use the beam B1 in a case where the signal of the symbol ##5 of the slot #n+4 is transmitted to the UE 30. The transfer unit 15 outputs the signal in the DCI format 0 received via the base station communication unit 11 to the UE communication unit 16 so as to transmit the signal in the symbol ##5 of the slot #n+4. The UE communication unit 16 of the repeater 10 transmits the signal in the DCI format 0 to the UE 30 using the beam B1 in the symbol ##5 of the slot #n+4, according to an instruction from the communication control unit 23 (step S232).

Next, in a symbol ##6-8 of the slot #n+4, the communication control unit 23 of the gNB 20 transmits a msg.2/A of communication using a DDB #1 to the repeater 10 using the DCI (step S233).

Since the signal is transmitted in the symbol ##6-8 of the slot #n+4, the communication control unit 23 specifies to use the beam B1 and instructs the UE communication unit 16 to use the beam B1 in a case where the signal of the symbol ##6-8 of the slot #n+4 is transmitted to the UE 30. The transfer unit 15 outputs the msg.2/A of the communication using the DDB #1 received via the base station communication unit 11 to the UE communication unit 16 so as to transmit the msg.2/A in the symbol ##6-8 of the slot #n+4. The UE communication unit 16 of the repeater 10 transmits the msg.2/A of the communication using the DDB #1 to the UE 30 using the beam B1 in the symbol ##6-8 of the slot #n+4, according to an instruction from the communication control unit 23 (step S234).

Next, in a symbol ##9 of the slot #n+4, the communication control unit 23 of the gNB 20 transmits a signal in the DCI format 0 to the repeater 10 (step S235).

Since the signal is transmitted in the symbol ##9 of the slot #n+4, the communication control unit 23 specifies to use the beam B2 and instructs the UE communication unit 16 to use the beam B2 in a case where the signal of the symbol ##9 of the slot #n+4 is transmitted to the UE 30. The transfer unit 15 outputs the signal in the DCI format 0 received via the base station communication unit 11 to the UE communication unit 16 so as to transmit the signal in the symbol ##9 of the slot #n+4. The UE communication unit 16 of the repeater 10 transmits the signal in the DCI format 0 to the UE 30 using the beam B2 in the symbol ##9 of the slot #n+4, according to an instruction from the communication control unit 23 (step S236).

Next, in a symbol ##10-12 of the slot #n+4, the communication control unit 23 of the gNB 20 transmits a msg.2/A of communication using a DDB #2 to the repeater 10 using the DCI (step S237).

Since the signal is transmitted in the symbol ##10-12 of the slot #n+4, the communication control unit 23 specifies to use the beam B2 and instructs the UE communication unit 16 to use the beam B2 in a case where the signal of the symbol ##10-12 of the slot #n+4 is transmitted to the UE 30. The transfer unit 15 outputs the msg.2/A of the communication using the DDB #2 received via the base station communication unit 11 to the UE communication unit 16 so as to transmit the msg.2/A in the symbol ##10-12 of the slot #n+4. The UE communication unit 16 of the repeater 10 transmits the msg.2/A of the communication using the DDB #2 to the UE 30 using the beam B2 in the symbol ##10-12 of the slot #n+4, according to an instruction from the communication control unit 23 (step S238).

In the slot #n+5 and the subsequent slots, the repeater 10 repeats transmitting the signal transmitted from the gNB 20 to the UE 30, using the beam designated by the DCI for beam ID notification.

As described above, in the wireless communication system according to the present embodiment, a base station controls the repeater by the RRC parameter until the msg.1/A is received and then, controls the repeater using the DCI. Since a base station device periodically notifies the RRC parameter, it is possible to periodically send the SSB. Furthermore, since it is unnecessary to transmit the DCI for beam ID notification until the msg.1/A is received, by sending the RRC parameter, it is possible to reduce an overhead caused by the DCI transmission.

### Third Embodiment

Next, a third embodiment will be described. A wireless communication system 1 according to the present embodiment is different from the first embodiment in that a repeater 10 spontaneously transmits different SSBs with different beams at different timings. The wireless communication system 1 according to the present embodiment is also represented by the block diagram in FIG. 2. In the following description, explanation of operations of the respective components similar to those of the first embodiment is omitted.

After establishment of initial coupling, a communication control unit 23 of a gNB 20 determines the number of SSBs to be used and an SSB index that is an identifier of each SSB from performance information of the repeater 10. Then, the communication control unit 23 notifies a communication control unit 14 of the repeater 10 of the SSB index of each SSB to be used. Thereafter, the communication control unit 23 of the gNB 20 establishes connection for data communication similarly to normal UE communication.

However, in a case where a beam to be transmitted from the gNB 20 side in the subsequent communication is directly designated, the communication control unit 23 of the gNB 20 transmits a DCI for beam ID notification to the repeater 10 and causes the repeater 10 to transmit a signal to a UE 30 with a beam having the designated beam ID. For example, the communication control unit 23 of the gNB 20 may cause the repeater 10 to spontaneously control the beam until a msg.1/A is received and to directly designate the beam thereafter and transmit the signal.

Here, as a format of the DCI for beam ID notification used in the present embodiment, the format illustrated in FIG. 3 can be used. However, in a case of a format illustrated in FIG. 4, since scheduling regarding the SSB and the msg.1/A overlaps scheduling notified by an RRI parameter, the use of the format illustrated in FIG. 4 is not suitable for the wireless communication system 1 according to the present embodiment.

After establishment of RRC connection, the communication control unit 14 of the repeater 10 receives communication setting information used to receive the DCI and the SSB index of each of the plurality of SSBs, from the gNB 20 via a base station communication unit 11.

Thereafter, the communication control unit 14 receives an SIB from the communication control unit 23 of the gNB 20. Next, the communication control unit 14 selects one of a plurality of beams that can be beamformed. Then, the communication control unit 14 transmits the received SIB to the UE 30 using the selected beam.

Next, the communication control unit 14 receives the SSB from the communication control unit 23 of the gNB 20. Next, the communication control unit 14 specifies the SSB index of the acquired SSB. Then, the communication control unit 14 transmits the acquired SSB to the UE 30, using the beam that has transmitted the SIB corresponding to the acquired SSB. Thereafter, the communication control unit 14 associates the SSB index with the beam, and then, determines the beam as a beam to be used for communication using the SSB. That is, in a case of performing communication using the SSB, the communication control unit 14 transmits a signal to the UE 30 using the determined beam. The communication control unit 14 executes the above processing in communication using all the SSBs.

However, in a case where the gNB 20 directly designates the beam to be transmitted in the subsequent communication, the communication control unit 14 receives a DCI for beam ID notification from the communication control unit 23 of the gNB 20. Thereafter, the communication control unit 14 notifies a UE communication unit 16 of a beam ID designated by the DCI for beam ID notification, for each symbol for each slot. The UE communication unit 16 causes the repeater 10 to transmit the signal to the UE 30 with a beam having the notified beam ID in each symbol for each slot.

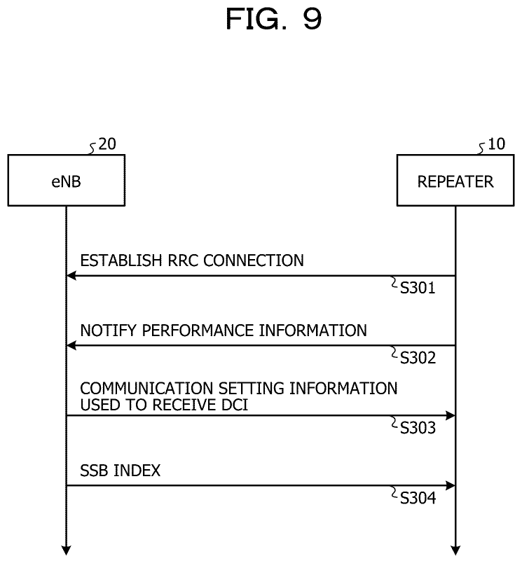

FIG. 9 is a flowchart of initial coupling between the gNB and the repeater according to the third embodiment. Next, a flow of the initial coupling between the gNB 20 and the repeater 10 according to the present embodiment will be described with reference to FIG. 9.

An RRC connection implementation unit 21 of the gNB 20 and an RRC connection implementation unit 12 of the repeater 10 execute an initial coupling procedure and establish RRC connection (step S301).

After the establishment of the RRC connection, a performance information notification unit 13 of the repeater 10 transmits performance information of the repeater 10 including presence or absence of a repeater function and the number of beams that can be transmitted and received, to the gNB 20 (step S302).

Next, a communication setting information transmission unit 22 of the gNB 20 receives a notification indicating completion of the RRC connection from the RRC connection implementation unit 21. Then, the communication setting information transmission unit 22 of the gNB 20 transmits communication setting information used to receive a DCI including information regarding a frequency resource for transmitting the DCI or the like to the communication control unit 14 of the repeater 10 (step S303)

Next, the communication control unit 23 of the gNB 20 determines the number of SSBs to be used and an SSB index of each SSB from the performance information of the repeater 10. Next, the communication control unit 23 of the gNB 20 transmits the SSB index of the SSB to be used to the communication control unit 14 of the repeater 10 (step S304).

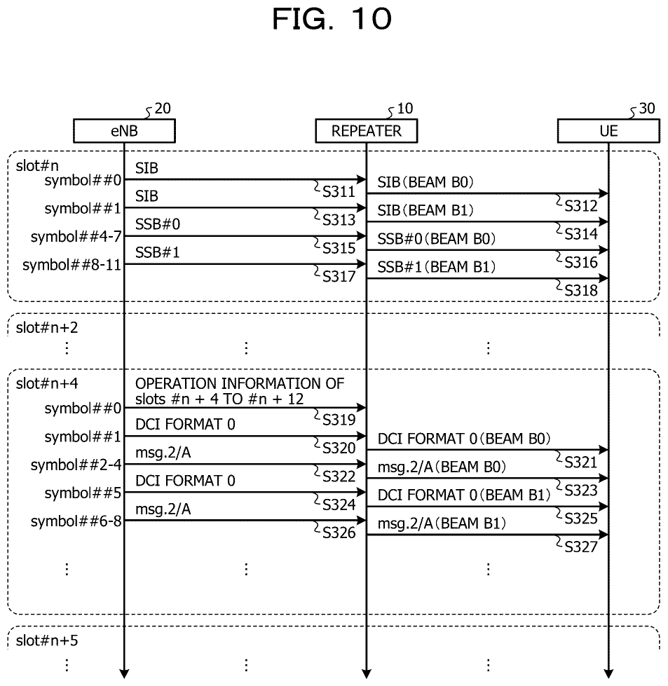

FIG. 10 is a flowchart of communication processing after establishment of the initial coupling by the wireless communication system according to the third embodiment. Next, a flow of the communication processing after the establishment of the initial coupling by the wireless communication system 1 according to the present embodiment will be described with reference to FIG. 10. Here, a case will be described where a beam transmitted from the gNB 20 side is directly designated from a slot #n+4 after receiving a msg.1/A.

The communication control unit 23 of the gNB 20 transmits the SIB in a symbol ##0 of a slot #n to the repeater 10 using an optimum beam with the repeater 10 via the communication unit 25 and performs scheduling (step S311).

The communication control unit 14 of the repeater 10 receives the SIB via the base station communication unit 11. Next, the communication control unit 14 selects a beam B0 from among beams that can be beamformed. Then, the communication control unit 14 transmits the SIB to the UE 30 in the symbol ##0 of the slot #n using the beam B0 selected via the UE communication unit 16, and performs scheduling (step S312).

Next, the communication control unit 23 of the gNB 20 transmits the SIB in a symbol ##1 of the slot #n to the repeater 10 using the optimum beam with the repeater 10 via the communication unit 25 and performs scheduling (step S313).

The communication control unit 14 of the repeater 10 receives the SIB via the base station communication unit 11. Next, the communication control unit 14 selects a beam B1 from among beams that can be beamformed. Then, the communication control unit 14 transmits the SIB to the UE 30 using the selected beam B1 via the UE communication unit 16 and performs scheduling (step S314).

Next, the communication control unit 23 of the gNB 20 transmits the SSB #0 to the repeater 10 in the symbol ##4-7 of the slot #n using the optimum beam with the repeater 10 via the communication unit 25 (step S315).

The communication control unit 14 of the repeater 10 receives the SSB #0 in the symbol ##4-7 of the slot #n, via the base station communication unit 11, according to the scheduling of the SIB received in the symbol ##0 of the slot #n. Next, the communication control unit 14 transmits the SSB #0 to the UE 30 in the symbol ##4-7 of the slot #n, via the UE communication unit 16 using the beam B0 used to transmit the SIB received in the symbol ##0 of the slot #n (step S316). Then, the communication control unit 14 associates the SSB index of the SSB #0 with the beam B0 and determines to use the beam B0 for communication using the SSB #0.

Next, the communication control unit 23 of the gNB 20 transmits the SSB #1 to the repeater 10 in the symbol ##8-11 of the slot #n using the optimum beam with the repeater 10 via the communication unit 25 (step S317).

The communication control unit 14 of the repeater 10 receives the SSB #1 in the symbol ##8-11 of the slot #n, via the base station communication unit 11, according to the scheduling of the SIB received in the symbol ##1 of the slot #n. Next, the communication control unit 14 transmits the SSB #1 to the UE 30 in the symbol ##8-11 of the slot #n, via the UE communication unit 16 using the beam B0 used to transmit the SIB received in the symbol ##0 of the slot #n (step S318). Then, the communication control unit 14 associates the SSB index of the SSB #1 with the beam B1 and determines to use the beam B1 for communication using the SSB #1.

Thereafter, the communication control unit 14 of the repeater 10 transmits the signal to the UE 30 using the beam B0 in a case of the communication using the SSB #0 and transmits the signal to the UE 30 using the beam B1 in a case of the communication using the SSB #1.

Thereafter, in the symbol ##0 of the slot #n+4 after reception of the msg.1/A, the communication control unit 23 of the gNB 20 transmits the operation information of the slots #n+4 to #n+12 to the repeater 10 via the communication unit 25 using the DCI for beam ID notification. The communication control unit 14 of the repeater 10 receives the DCI for beam ID notification in the symbol ##0 of the slot #n and acquires the operation information of the slots #n+1 to #n+9 (step S319). At this time, the operation information of the slots #n+1 to #n+9 transmitted by the communication control unit 23 includes, for example, information indicating that the beam B0 is used in the symbol ##1-4 of the slot #n+4 and the beam B1 is used in the symbol ##5-8 of the slot #n+4.

Next, in a symbol ##1 of the slot #n+4, the communication control unit 23 of the gNB 20 transmits a signal in the DCI format 0 to the repeater 10 (step S320).

Since the signal is transmitted in the symbol ##1 of the slot #n+4, the communication control unit 23 of the repeater 10 specifies to use the beam B0 and instructs the UE communication unit 16 to use the beam B0 in a case where the signal of the symbol ##1 of the slot #n+4 is transmitted to the UE 30. The transfer unit 15 of the repeater 10 outputs the signal in the DCI format 0 received via the base station communication unit 11 to the UE communication unit 16 so as to transmit the signal in the symbol ##1 of the slot #n+4. Then, the UE communication unit 16 of the repeater 10 transmits the signal in the DCI format 0 to the UE 30 using the beam B0 in the symbol ##1 of the slot #n+4, according to an instruction from the communication control unit 23 (step S321).

Next, in a symbol ##2-4 of the slot #n+4, the communication control unit 23 of the gNB 20 transmits a msg.2/A of communication using a DDB #0 to the repeater 10 using the DCI (step S322).

Since the signal is transmitted in the symbol ##4-7 of the slot #n+4, the communication control unit 23 specifies to use the beam B0 and instructs the UE communication unit 16 to use the beam B0 in a case where the signal of the symbol ##4-7 of the slot #n+4 is transmitted to the UE 30. The transfer unit 15 outputs the msg.2/A of the communication using the DDB #0 received via the base station communication unit 11 to the UE communication unit 16 so as to transmit the msg.2/A in the symbol ##4-7 of the slot #n+4. The UE communication unit 16 of the repeater 10 transmits the msg.2/A of the communication using the DDB #0 to the UE 30 using the beam B0 in the symbol ##4-7 of the slot #n+4, according to an instruction from the communication control unit 23 (step S323).

Next, in a symbol ##5 of the slot #n+4, the communication control unit 23 of the gNB 20 transmits the signal in the DCI format 0 to the repeater 10 (step S324).

Since the signal is transmitted in the symbol ##5 of the slot #n+4, the communication control unit 23 specifies to use the beam B1 and instructs the UE communication unit 16 to use the beam B1 in a case where the signal of the symbol ##5 of the slot #n+4 is transmitted to the UE 30. The transfer unit 15 outputs the signal in the DCI format 0 received via the base station communication unit 11 to the UE communication unit 16 so as to transmit the signal in the symbol ##5 of the slot #n+4. The UE communication unit 16 of the repeater 10 transmits the signal in the DCI format 0 to the UE 30 using the beam B1 in the symbol ##5 of the slot #n+4, according to an instruction from the communication control unit 23 (step S325).

Next, in a symbol ##6-8 of the slot #n+4, the communication control unit 23 of the gNB 20 transmits a msg.2/A of communication using a DDB #1 to the repeater 10 using the DCI (step S326).

Since the signal is transmitted in the symbol ##6-8 of the slot #n+4, the communication control unit 23 specifies to use the beam B1 and instructs the UE communication unit 16 to use the beam B1 in a case where the signal of the symbol ##6-8 of the slot #n+4 is transmitted to the UE 30. The transfer unit 15 outputs the msg.2/A of the communication using the DDB #1 received via the base station communication unit 11 to the UE communication unit 16 so as to transmit the msg.2/A in the symbol ##6-8 of the slot #n+4. The UE communication unit 16 of the repeater 10 transmits the msg.2/A of the communication using the DDB #1 to the UE 30 using the beam B1 in the symbol ##6-8 of the slot #n+4, according to an instruction from the communication control unit 23 (step S327).

Hereinafter, the repeater 10 repeats transmitting the signal transmitted from the gNB 20 to the UE 30, using the beam designated by the DCI for beam ID notification.

As described above, in the wireless communication system according to the present embodiment, the repeater spontaneously determines the beam corresponding to the SSB and communicates with the UE, without receiving control using the DCI and the RRC parameter from the gNB. As a result, it is sufficient for the gNB to notify the repeater of the SSB index, so as to relay an SSB signal. Therefore, it is possible to reduce an overhead of a control signal.

### Fourth Embodiment

Next, a fourth embodiment will be described. A wireless communication system 1 according to the present embodiment is different from the first embodiment in that an operation of a repeater 10 is turned off in a symbol in which a beam to be used is not scheduled. The wireless communication system 1 according to the present embodiment is also represented by the block diagram in FIG. 2. In the following description, explanation of operations of the respective components similar to those of the first embodiment is omitted.

A communication control unit 14 of the repeater 10 receives a DCI for beam ID notification from a communication control unit 23 of a gNB 20. Then, the communication control unit 14 refers to the DCI for beam ID notification and confirms a beam ID used for each symbol for each slot. Then, the communication control unit 14 notifies a UE communication unit 16 of the beam ID for each symbol for each slot.

Thereafter, the communication control unit 14 turns off the operation of the repeater 10 in a symbol in which a beam ID of a beam used in each slot is not designated, in the DCI for beam ID notification. Here, to turn off the operation of the repeater 10, a power supply of the repeater 10 may be completely turned off, or the repeater 10 may be in a power saving mode that is a state where communication can be immediately performed, in consideration of a delay until communication start.

The UE communication unit 16 causes the repeater 10 to transmit the signal to the UE 30 with a beam having the notified beam ID in each symbol for each slot.

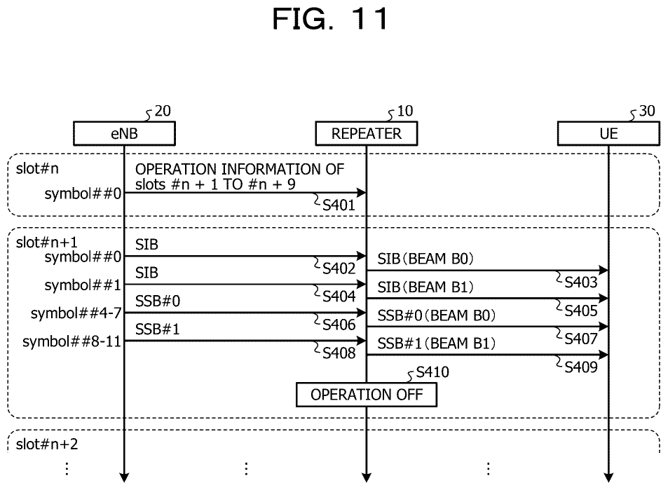

FIG. 11 is a flowchart of communication processing after establishment of initial coupling by the wireless communication system according to the fourth embodiment. Next, a flow of the communication processing after the establishment of the initial coupling by the wireless communication system 1 according to the present embodiment will be described with reference to FIG. 11.

The communication control unit 23 of the gNB 20 transmits operation information of slots #n+1 to #n+9 in a symbol ##0 of a slot #n using the DCI for beam ID notification, to the repeater 10 via a communication unit 25. The communication control unit 14 of the repeater 10 receives the DCI for beam ID notification in the symbol ##0 of the slot #n and acquires the operation information of the slots #n+1 to #n+9 (step S401). At this time, the operation information of the slots #n+1 to #n+9 transmitted by the communication control unit 23 includes, for example, information indicating that a beam B0 is used in the symbol ##0 of the slot #n+1 and a beam B1 is used in a symbol ##1 of the slot #n+1. Furthermore, the operation information of the slots #n+1 to #n+9 includes information indicating that the beam B0 is used in a symbol ##4-7 of the slot #n+1 and the beam B1 is used in a symbol ##8-11 of the slot #n+1.

Next, in the symbol ##0 of the slot #n+1, the communication control unit 23 of the gNB 20 transmits an SI to the repeater 10 using a DCI format 0 (step S402).

Since the signal is transmitted in the symbol ##0 of the slot #n+1, the communication control unit 23 of the repeater 10 specifies to use the beam B0 and instructs the UE communication unit 16 to use the beam B0 in a case where the signal of the symbol ##0 of the slot #n+1 is transmitted to the UE 30. A transfer unit 15 of the repeater 10 outputs an SIB received via the base station communication unit 11 to the UE communication unit 16 so as to transmit the SIB in the symbol ##0 of the slot #n+1. Then, the UE communication unit 16 of the repeater 10 transmits the SIB to the UE 30 using the beam B0 in the symbol ##0 of the slot #n+1, according to an instruction from the communication control unit 23 and performs scheduling (step S403).

Next, in the symbol ##1 of the slot #n+1, the communication control unit 23 of the gNB 20 transmits the SIB to the repeater 10 using the DCI format 0 (step S404).

Since the signal is transmitted in the symbol ##1 of the slot #n+1, the communication control unit 23 of the repeater 10 specifies to use the beam B1 and instructs the UE communication unit 16 to use the beam B1 in a case where the signal of the symbol ##1 of the slot #n+1 is transmitted to the UE 30. The transfer unit 15 of the repeater 10 outputs the SIB received via the base station communication unit 11 to the UE communication unit 16 so as to transmit the SIB in the symbol ##1 of the slot #n+1. Then, the UE communication unit 16 of the repeater 10 transmits the SIB to the UE 30 using the beam B1 in the symbol ##1 of the slot #n+1, according to an instruction from the communication control unit 23 and performs scheduling (step S405).

Next, in a symbol ##4-7 of the slot #n+1, the communication control unit 23 of the gNB 20 transmits an SSB #0 to the repeater 10 using the DCI (step S406).

Since the signal is transmitted in the symbol ##4-7 of the slot #n+1, the communication control unit 23 specifies to use the beam B0 and instructs the UE communication unit 16 to use the beam B0 in a case where the signal of the symbol ##4-7 of the slot #n+1 is transmitted to the UE 30. The transfer unit 15 outputs the SSB #0 received via the base station communication unit 11 to the UE communication unit 16 so as to transmit the SSB #0 in the symbol ##4-7 of the slot #n+1. The UE communication unit 16 of the repeater 10 transmits the SSB #0 to the UE 30 using the beam B0 in the symbol ##4-7 of the slot #n+1, according to an instruction from the communication control unit 23 (step S407).

Next, in the symbol ##8-11 of the slot #n+1, the communication control unit 23 of the gNB 20 transmits an SSB #1 to the repeater 10 using the DCI (step S408).

Since the signal is transmitted in the symbol ##8-11 of the slot #n+1, the communication control unit 23 specifies to use the beam B1 and instructs the UE communication unit 16 to use the beam B1 in a case where the signal of the symbol ##8-11 of the slot #n+1 is transmitted to the UE 30. The transfer unit 15 outputs the SSB #1 received via the base station communication unit 11 to the UE communication unit 16 so as to transmit the SSB #1 in the symbol ##8-11 of the slot #n+1. The UE communication unit 16 of the repeater 10 transmits the SSB #1 to the UE 30 using the beam B1 in the symbol ##8-11 of the slot #n+1, according to an instruction from the communication control unit 23 (step S409).

Since a beam ID of a beam to be used is not designated in the subsequent symbol of the slot #n+1, the communication control unit 14 of the repeater 10 turns off the repeater 10 (step S410).

Thereafter, the communication control unit 14 repeatedly turns on the repeater 10 and resumes communication, in a symbol in which the beam ID is designated, for each slot, and repeatedly turns off the repeater 10 in a symbol in which the beam ID is not designated.

Here, in the present embodiment, a case has been described where the function for turning off the repeater 10 in the symbol in which the beam ID is not designated is added to the communication system according to the first embodiment. However, this function can be added to the second or third embodiment.

As described above, in the wireless communication system according to the present embodiment, the repeater is turned off in the symbol in which the beam ID is not designated. As a result, since the repeater can be turned off when unnecessary, it is possible to suppress an increase in power consumption and an increase in noise. Furthermore, since the repeater can be turned on/off according to the schedule of the symbol, without sending on/off control information, it is possible to achieve implementation with a simple configuration without increasing an overhead of a control signal.

### Fifth Embodiment

Next, a fifth embodiment will be described. In a wireless communication system 1 according to the present embodiment, a repeater 10 is turned off in a case where an unused beam ID is designated. The wireless communication system 1 according to the present embodiment is also represented by the block diagram in FIG. 2. In the following description, explanation of operations of the respective components similar to those of the first embodiment is omitted.

For example, a case will be described where the maximum number of beams of the repeater 10 is eight and beams B1 to B8 are used as beam IDs.

A communication control unit 14 of the repeater 10 receives a DCI for beam ID notification from a communication control unit 23 of a gNB 20. Then, the communication control unit 14 refers to the DCI for beam ID notification and confirms a beam ID used for each symbol for each slot. Here, in a case where the beams B1 to B8 are designated as the beam IDs, the communication control unit 14 notifies a UE communication unit 16 of the beam ID for each symbol for each slot.

On the other hand, in a case where a beam ID other than the beams B1 to B8 is designated by the DCI for beam ID notification, for example, in a case where a beam B12 is designated, the communication control unit 14 turns off the repeater 10. Thereafter, in a case where a predetermined condition is satisfied, the communication control unit 14 turns on the repeater 10. For example, in a case where the base station communication unit 11 is caused to receive the DCI and receives the DCI for beam ID notification, in a case where the beams B1 to B8 are designated in each symbol for each slot, the communication control unit 14 turns on the repeater 10.

As described above, in the wireless communication device according to the present embodiment, in a case where the unused beam ID is designated, the repeater is turned off. As a result, since the repeater can be turned off when unnecessary, it is possible to suppress an increase in power consumption and an increase in noise.

### Sixth Embodiment

In each of the above embodiments, a case has been described where the repeater 10 communicates with the UE 30 using different beams at different timings for each SSB for transmission of the SSB. However, a signal to be handled is not limited to this. For example, the functions described in each of the above embodiments can be applied to transmission of a CSI-RS or a PDSCH/PDCCH. A beam used to transmit the channel state information-reference signal (CSI-RS) or the physical downlink shared channel (PDSCH)/physical downlink control channel (PDCCH) may be the same beam as the beam used to transmit the SSB and may be a narrowband beam.

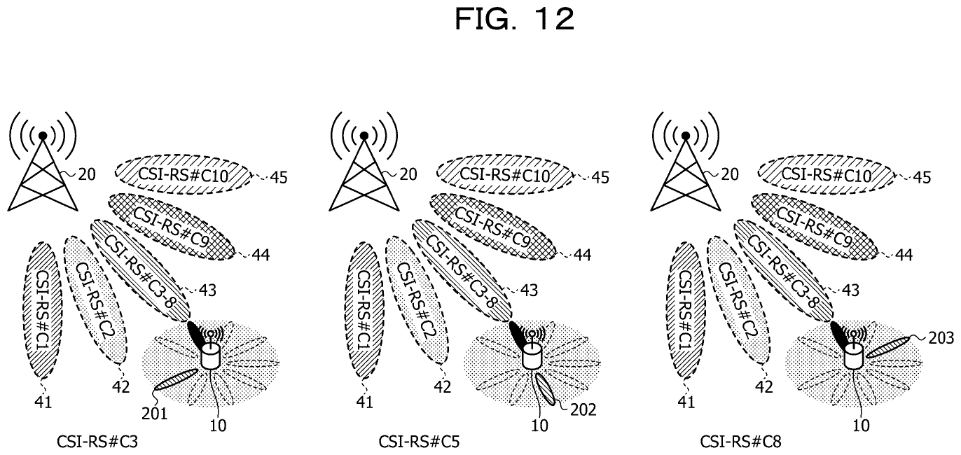

FIG. 12 is a diagram for explaining an operation in a case where different beams at different timings are used to transmit the plurality of CSI-RSs. Next, the operation in a case where the different beams at the different timings are used to transmit the plurality of CSI-RSs will be described with reference to FIG. 12.

In FIG. 12, a signal control unit 23 of a gNB 20 transmits a CSI-RS #C1, a CSI-RS #C2, CSI-RSs #C3 to #8, a CSI-RS #C9, and a CSI-RS #C10 respectively with different beams.

Specifically, the communication control unit 23 transmits a DCI for beam ID notification to a repeater 10 using an optimum beam with the repeater 10 and designates a beam ID of a beam used for each symbol for each slot. Then, the signal control unit 23 transmits each of the CSI-RSs #C3 to #C8 to the repeater 10 through TDM transmission using the optimum beam with the repeater 10. At this time, the signal control unit 23 transmits the CSI-RSs #C3 to #C8 using symbols for each slot in which different beams are used.

A communication control unit 14 of the repeater 10 receives the DCI for beam ID notification from the communication control unit 23 of the gNB 20 via a base station communication unit 11. Then, the communication control unit 14 confirms a beam ID of a beam to be used for each symbol for each slot.

Thereafter, when the base station communication unit 11 receives the CSI-RS #C3 from the communication control unit 23 of the gNB 20, the communication control unit 14 notifies a UE communication unit 16 of a beam ID of a beam used in the received slot and signal. Similarly, when the base station communication unit 11 receives each of the CSI-RSs #C4 to C8 from the communication control unit 23 of the gNB 20, the communication control unit 14 notifies the UE communication unit 16 of each beam ID of the beam used in the received slot and packet.

The UE communication unit 16 receives the notification of the beam ID of the beam used in the slot and the signal used to receive the CSI-RS #C3, from the UE communication unit 16. Then, the UE communication unit 16 transmits the CSI-RS #C3 to a UE 30 in the received slot and signal, using the designated beam ID. For example, as illustrated in FIG. 12, the UE communication unit 16 transmits the CSI-RS #C3 to the UE 30 using a beam 201.

Similarly, the UE communication unit 16 receives each notification of the beam ID of the beam used in the slot and the signal used to receive each of the CSI-RSs #C4 to #C8, from the UE communication unit 16. Then, the UE communication unit 16 transmits each of the CSI-RSs #C4 to #C8 to the UE 30 in the received slot and signal, using the designated beam ID. For example, as illustrated in FIG. 12, the UE communication unit 16 transmits the CSI-RS #C5 to the UE 30 using a beam 202 and transmits the CSI-RS #C8 to the UE 30 using a beam 203.

As described above, in the wireless communication system according to the present embodiment, the repeater transmits the different CSI-RSs to the UE using the different beams at the different timings. As a result, the UE can acquire a reception strength of the CSI-RS of each beam, and the base station device can select the optimum beam between the repeater and the UE. Therefore, a coverage can be appropriately expanded, and efficient communication can be performed.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A relay device comprising:
communication circuitry; and
processor circuitry coupled to the communication circuitry, the processor circuitry being configured to perform processing comprising:
first communication processing to receive a plurality of signals from a first wireless communication device via the communication circuitry;
communication control processing to allocate, to each of the plurality of signals received by the first communication processing, a corresponding transmission timing and beam used for wireless communication; and
second communication processing to transmit each signal to a second wireless communication device via the communication circuitry by using the beam allocated by the communication control processing, at the transmission timing allocated by the communication control processing, wherein
the communication control processing includes receiving first information that includes a beam index indicating the beam.

2. The relay device according to claim 1, wherein the first communication processing includes receiving each of the signals in a time division multiplexing method.

3. The relay device according to claim 1, wherein the first information includes information that indicates the transmission timing allocated to each signal of the plurality of signals.

4. The relay device according to claim 3, wherein the communication control processing includes receiving a downlink control information that includes the first information.

5. The relay device according to claim 3, wherein the communication control processing includes receiving the first information as a parameter at the time of establishment of connection for wireless resource control with the first wireless communication device.

6. The relay device according to claim 3, wherein the communication control processing includes stopping a predetermined operation of the relay device at a timing that is not allocated to any one signal of the plurality of signals, as the transmission timing in the first information.

7. The relay device according to claim 3, wherein the communication control processing includes stopping a predetermined operation of the relay device in a case where information regarding a predetermined beam is included in the first information.

8. The relay device according to claim 1, wherein the communication control processing includes receiving identification information of each beam from the first wireless communication device, selecting the beam to be allocated to each signal of the plurality of signals, and causing the processor circuitry to perform the second communication processing via the communication circuitry by using the identification information of the selected beam.

9. A base station device comprising:
communication circuitry; and
processor circuitry coupled to the communication circuitry, the processor circuitry being configured to perform processing including:
communication processing to transmit a plurality of signals to a relay device via the communication circuitry; and
communication control processing including
transmitting first information to the relay device via the communication circuitry, the first information indicating, for to each of the plurality of signals, allocation of a corresponding transmission timing and a beam index of beam used for wireless communication, to cause the relay device to transmit each signal of the plurality of signals to a second wireless communication device by using the beam indicated by the beam index, at the transmission timing.

10. A wireless communication system having a relay device, comprising:
a first wireless communication device configured to transmit a plurality of signals to the relay device; and
a second wireless communication device configured to:
receive the plurality of signals, from the first wireless communication device;
allocate, for each signal of the plurality of signals, a corresponding transmission timing and beam used for wireless communication; and
transmit each signal of the plurality of signals to the second wireless communication device by using the beam, at the transmission timing.
